(19) United States
(12) Patent Application Publication
(10) Pub. No.: US 2010/0294912 A1
(43) Pub. Date: Nov. 25, 2010

(54) CERAMIC TOOL HAVING A MATERIAL APPLIED TO THE SURFACE

(75) Inventor: Antony Dodworth, Lincolnshire (GB)

Correspondence Address: SALTER & MICHAELSON;THE HERITAGE BUILDING, 321 SOUTH MAIN STREET, PROVIDENCE, RI, 029037128, US

(73) Assignee: BENTLEY MOTORS LIMITED, Cheshire (GB)

(21) Appl. No.: 12/515,302

(22) PCT Filed: Nov. 16, 2007
(86) PCT No.: PCT/GB07/04391

§ 371 Date: Feb. 23, 2010

(30) Foreign Application Priority Data
Nov. 18, 2006 (GB) 0623048.6

(51) Int. Cl. B29C 33/02; B29C 33/56

(52) U.S. Cl. 249/78; 249/114.1; 427/133

(57) ABSTRACT

In a ceramic tool and associated method of making it, a ceramic base is infused with a material. The material is preferably a metal based compound advantageously chrome oxide. The chemical formulation of the material can be modified in order to optimize the rate of material deposition and the desired surface performance. The depth of the infusion is advantageously 0.1 to 1 mm preferably 0.25 mm. The moulding surface of the tool may be treated to vapour or oat blasting. The resultant tool has a longer life and may be used without a release agent.

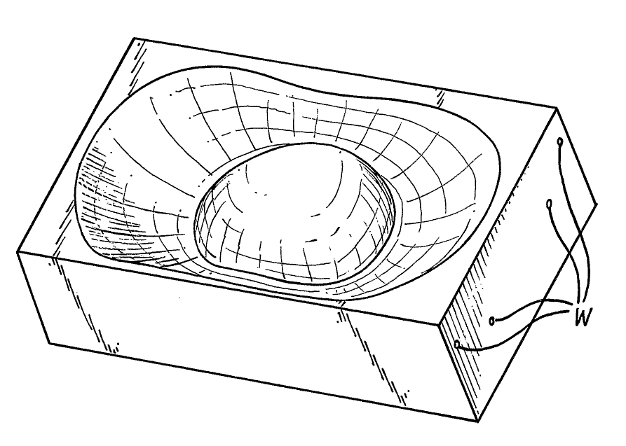

The present invention relates to ceramic tooling.

A use of the ceramic tooling is in the moulding process described in International application number PCT/GB2005/004196 in the name of the same applicant. Traditionally tooling made in either metal or composite has limitations in that a release agent is generally required to facilitate removal of a moulded part from the mould and, in the case of a composite mould, the mould may have a relatively limited life. By adopting a ceramic moulding tool produced from a high quality master male pattern or manufactured directly, the need for a release agent may be eliminated and potential tool life increased for example from about 250 moulded products per tool for a composite tool to about 10,000 moulded products per tool. This latter FIGURE is similar to the production rates which can be achieved with a metal tool. Ceramic tools do however suffer from surface porosity which may adversely affect the moulding process. It is an object of the present invention to mitigate or eliminate this disadvantage.

According to one aspect of the present invention, there is provided a ceramic tool having a material applied to the surface thereof, such that the applied material is infused into the surface of the ceramic.

According to another aspect of the present invention, there is provided a method of making a moulding tool including the steps of forming a ceramic base in the required shape and applying a material to the moulding surface thereof so that the applied material infuses the ceramic material

In a preferred embodiment of the invention, the material applied to the surface of the ceramic provides a hard, durable, smooth, high temperature resistant surface and obviates the need for a release agent in use of the tool. Advantageously, the material is a metal based compound, preferably chrome oxide. The depth of the infusion of material is advantageously between 0.1 and 2 mm preferably 0.25 mm. The temperature, rate of thermal change, water content, drying sequence, firing and ceramic formulation are all chosen to minimize craters in the surface of the tool. Craters produced may be filled. The ceramic tool surface is advantageously subjected to vapour, oat or light sand blasting to alter the surface finish after part or total firing of the ceramic but prior to application of the material. Preferably the tool is provided with heating means. Preferably, the heating means comprise electrical heater wires disposed in microbores formed in the ceramic. The microbores are advantageously formed by means of slim plastic tubing or rods disposed in the ceramic during the wet casting stage. After the tool solidifies, the plastic is melted to leave the bores.

Alternatively, the heating means comprise oil galleries provided for the passage of heating oil. Preferably, thermocouples or alternative means are provided for the measurement of surface temperature of the tool and means are provided for varying the wattage input to the elements. The electrical heating means preferably comprise means for varying the electrical resistance of the wire.

The structural integrity of the ceramic tool may be significantly improved by including reinforcing fibre or matting comprising e.g. horsehair, silicate ceramic or alumina fibre into the tool substrate. However it is important that the thermal and chemical characteristics of any such inclusion are compatible with the principal ceramic mould material.

In order that the invention may be more clearly understood, embodiments thereof will now be described by way of example with reference to the single FIGURE of the accompanying drawing, which shows a plan perspective view of a ceramic tool.

Referring to the drawing, the basic ceramic tool is conventional and made in the usual way. Suitable ceramics are alumina or silica based but other ceramics such as borides, carbides or nitrides may be used. A metal based compound such as chrome oxide is applied to the surface of the ceramic by electrostatic deposition, controlled spraying of a solution or application of a liquid slurry containing the required metal based compound. The thickness of the deposition is preferably accurately controlled in order to optimize the surface hardness of the tool, tool durability and quality of finish of the tool. In addition, the chemical formulation of the applied metal based compound can be modified in order to optimize the rate of deposition and achieve the desired surface performance. The quality of the surface finish is extremely important to the subsequent use of any tooling and the moulded parts produced. The chrome oxide is infused into the surface of the ceramic tool during the application process.

In an alternative preferred arrangement, chrome oxide is infused by applying it to the ceramic tool as a solution in chromic acid. Several layers of solution may be painted or sprayed onto the surface of the tool. Usually this application step takes place after a first firing of the ceramic but before a final firing. During this process the chromic acid evaporates leaving the chrome oxide infused into the surface of the ceramic of the tool. Typical penetration of chrome oxide into the ceramic is in the range 0.1 to 1 mm, preferably 0.25 mm.

In both the above cases the disposition of the chrome oxide in the surface of the ceramic is a true infusion, However, small particles of chromic oxide may be present at the surface of the ceramic and in some cases chrome oxide remaining at the surface may form a coating on that surface.

If the tool is to be used for a metal sprayed component the surface must be free from all minute craters or pock marks into which the sprayed metal can key and prevent easy part extraction from the tool. These craters are usually generated by the water content of the tool surface layer, rate of freezing (needed to remove the ceramic from its former/pattern) and the attitude of the surface of the mould tool.

Although the infusion process advantageously takes place at ambient temperatures, the number of craters can be minimized by careful control of the ceramic mixing and process control (temperature, rate of thermal change, water content/drying sequence, firing and ceramic formulation) as well as the design of the tool. Craters may also be filled.

The quality of the finish of the tool can be altered by vapour, oat or light sand blasting the tool surface after part or total firing and prior to the application of the chrome oxide.

This blasting leaves extremely small, micro undulations typically having a dimension of 30 microns (near invisible) on the surface. This blasting treatment provides a surface onto which sprayed metal can grip. The undulations will also be transferred to a sprayed metal surface of the component produced. However, if the component is to be painted, their removal may not be necessary since they will help the keying of the paint. Similarly, if the part doesn't need a class one finish or is to be plated they may be acceptable. However if the component requires a mirror finish it can be polished as a normal metal pressing.

In the process of oat blasting the husks of oats are propelled towards the surface to be treated. The soft nature of the husks produces a polished finish on the surface of the tool rather than the previously mentioned undulations. The use of husks also enables the process to be used on a softer partially fired tool.

Also, where the ceramic mould is to be used for a metal sprayed product, where the surface of the mould is sprayed with a metal which becomes the surface layer of the moulded product, the infused material will also be chosen having regard to the material which is to be sprayed. For ex\ample chrome oxide has been found to be particularly advantageous for stainless steel, but other material may be appropriate for copper, aluminum, phoretic steels and titanium.

It will be necessary to heat the tool prior to and during a moulding operation using the above tool. Prior to moulding the tool may be heated to 170° C. A suitable moulding curing temperature for epoxys is approximately 180° C. Other temperatures may be appropriate for other moulding materials. For example, thermoplastic material may require a curing temperature in the region of 410° C. In order to generate and control heating of the mould over this range of temperatures the mould is provided with electrical heater wires (referenced W on the drawing) or other electrical heating means such as a carbon fibre mat. As a non-electrical alternative oil conducting galleries could be provided in the tool although it would be difficult to produce as wide a temperature range with oil galleries as with electrical heater wires. The electrical heater wires are advantageously fine heater wires installed in microbores in the tool in order to maximize the integrity of the tool. The microbores are generated by placing slim plastic tubing or rods in the ceramic tool at its wet casting stage. After the tool is frozen and removed from the pattern, it is then fired and the plastic is melted away leaving the fine wire holes. The heating elements can then be threaded into the tool.

In the carbon fibre mat alternative, the mat is laid on a first layer of ceramic and a second layer of ceramic placed on top prior to firing.

The surface temperature of the tool can be measured by the use of thermocouples or other suitable means, and the wattage input to the elements adjusted to suit the required temperatures.

By adopting this technique, the elements can be changed so that the electrical resistance of the wire can be selected to vary the heat input needed for any chosen length of wire.

It will be appreciated that the above embodiments have been described by way of example only and that many variations are possible within the scope of the invention. For example, although chrome oxide is preferred as the metal based compound to be applied to the surface of the ceramic tool other materials may also be used as long as the material selected provides a hard, durable, smooth high temperature resistant surface which facilitates release of the moulded product.

1. A ceramic tool having a material applied to the surface thereof characterized in that the applied material is infused into the surface of the ceramic.

2. A ceramic tool as claimed in claim 1, in which the material is a metal based compound.

3. A ceramic tool as claimed in claim 2, in which the metal based compound is chrome oxide.

4. A ceramic tool as claimed in claim 3, in which the depth of the infusion of material is between 0.1 and 2 mm.

5. A ceramic tool as claimed in claim 4, in which the depth of infusion of material is 0.25 mm.

6. A ceramic tool as claimed in claim 1, comprising heating means.

7. A ceramic tool as claimed in claim 6, in which the heating means comprises electrical heater wires disposed in bores formed in the ceramic.

8. A ceramic tool as claimed in claim 6, in which the heating means comprises a carbon fibre mat disposed within the mass of ceramic.

9. A ceramic tool as claimed in claim 8, in which the electrical heater means are provided with means to measure the surface temperature of the tool.

10. A ceramic tool as claimed in claim 9, in which the means to measure comprises one or more thermocouples.

11. A ceramic tool as claimed in claim 7, in which means are provided for varying power input to the heater means.

12. A ceramic tool as claimed in claim 7, in which means are provided for varying the electrical resistance of the wires.

13. A ceramic tool as claimed in claim 6, in which the heating means comprise oil galleries for the passage of heating oil.

14. A ceramic tool as claimed in claim 1, in which reinforcing fibre or matting are disposed in the tool to improve its structural integrity.

15. A ceramic tool as claimed in claim 14, in which the reinforcing fibre or matting is horsehair, silicate, ceramic or alumina fibre.

16. A method of making a molding tool including the step of forming a ceramic base in the required shape characterized by the step of applying a material to the molding surface thereof so that the applied material infuses the ceramic.

17. A method as claimed in claim 16, in which the ceramic is infused with a metal based compound.

18. A method as claimed in claim 16, in which the ceramic is infused with chrome oxide.

19. A method as claimed in claim 16, in which material is infused to a depth of between 0.1 and 2 mm.

20. A method as claimed in claim 16, in which material is infused to a depth of 0.25 mm.

21. A method as claimed in claim 16, in which temperature, rate of thermal change, water content, drying sequence, firing and ceramic formulation are all chosen to minimize craters in the surface of the tool.

22. A method as claimed in claim 16, in which craters are filled.

23. A method as claimed in claim 16, in which the ceramic tool surface is subjected to vapour blasting prior to application of material.

24. A method as claimed in claim 23, in which the blasting is vapour blasting.

25. A method as claimed in claim 23, in which the blasting is oat blasting.

26. A method as claimed in claim 23, in which the blasting is light sand blasting.

27. A method as claimed in claim 16, in which the tool is heated.
